(19) United States
(12) Patent Application Publication
(10) Pub. No.: US 2015/0252252 A1
(43) Pub. Date: Sep. 10, 2015

(54) HUMIDITY-RESISTANT SELF-SUSPENDING PROPPANTS

(71) Applicant: Self-Suspending Proppant LLC, Cambridge, MA (US)

(72) Inventors: David S. Soane, Chestnut Hill, MA (US); Robert P. Mahoney, Newbury, MA (US); Marie K. Herring, Watertown, MA (US); Kevin P. Kincaid, Salt Lake City, UT (US); Philip Wuthrich, Belmont, MA (US)

(21) Appl. No.: 14/631,900

(22) Filed: Feb. 26, 2015

Related U.S. Application Data
(60) Provisional application No. 61/948,212, filed on Mar. 5, 2014.

(51) Int. Cl. C09K 8/80; E21B 43/267; E21B 43/26

(52) U.S. Cl. CPC C09K 8/805; E21B 43/26; E21B 43/267

(57) ABSTRACT

A dry self-suspending proppant comprises a proppant particle substrate and a coating on the proppant particle substrate. The coating is made from a hydrogel-forming polymer and a polyol or polyamine which have been crosslinked together by means of a covalent crosslinking agent.

### CROSS REFERENCE TO RELATED APPLICATION

This application claims the benefit of U.S. Provisional Application No. 61/948,212, filed Mar. 5, 2014, which disclosure is incorporated by reference in its entirety.

### BACKGROUND

In our earlier applications including Ser. No. 13/599,828, filed Aug. 30, 2012, Ser. No. 13/838,806, filed Mar. 15, 2013, Ser. No. 13/939,965, filed Jul. 11, 2013, and Ser. No. 14/197,596, filed Mar. 5, 2014, we disclose self-suspending proppants which take the form of a proppant particle substrate carrying a coating of a hydrogel-forming polymer. As further described there, these proppants are formulated in such a way that they rapidly swell when contacted with aqueous fracturing fluids to form hydrogel coatings which are large enough to significantly increase the buoyancy of these proppants during their transport downhole yet durable enough to remain largely intact until they reach their ultimate use locations. The disclosures of all of these earlier applications are incorporated herein by reference in their entireties.

The easiest way of making these self-suspending proppants available commercially will be by manufacture in a central location and then transport in bulk to individual well sites. For this purpose, these proppants desirably should resemble conventional proppants in terms of bulk handling properties in the sense of being dry and free-flowing when stored and transported. In this context, “dry” will be understood to mean that these proppants have not been combined with a carrier liquid such as would occur if they were present in an a fracturing fluid or other suspension or slurry. In addition, “free-flowing” will be understood to mean that any clumping or agglomeration that might occur when these proppants are stored for more than a few days can be broken up by gentle agitation.

As explained in our earlier applications, keeping self-suspending proppants free-flowing when stored and transported can become a problem, because at least some of the hydrogel-forming polymer coatings on these proppants may be hygroscopic, at least to some degree. While this may not represent a problem in northern climes in wintertime, in the summertime particularly in the South these polymers can absorb enough atmospheric moisture to cause them to “cake,” i.e., to amalgamate into large, tough, coherent, solid masses or “cakes,” thereby destroying the free-flowing nature of this product.

### SUMMARY

In accordance with this invention, we have found that this humidity-caking problem can be eliminated essentially completely or at least substantially reduced by including in the coating compositions used to form these self-suspending proppants (1) an organofunctional compound comprising a polyol, a polyamine or a mixture of both and (2) a covalent crosslinking agent for the hydrogel-forming polymer in these compositions which is also capable of chemically reacting with this organofunctional compound.

Thus, this invention provides a dry self-suspending proppant comprising a proppant particle substrate and a coating on the proppant particle substrate, wherein the coating comprises the reaction product obtained when a hydrogel-forming polymer is crosslinked by means of a covalent crosslinking agent in the presence of an organofunctional compound comprising one or more polyols, one or more polyamines or a mixture thereof, wherein the covalent crosslinking agent is also capable of reacting with the organofunctional compound.

In addition, this invention also provides an aqueous fracturing fluid comprising an aqueous carrier liquid containing this self-suspending proppant.

In addition, this invention further provides a method for fracturing a geological formation comprising pumping this fracturing fluid into this formation.

Finally, this invention also provides a method for making this self-suspending proppant in which a proppant particle substrate is combined with a coating composition comprising an aqueous emulsion of the hydrogel-forming polymer, the organofunctional compound and the covalent crosslinking agent, after which the carrier liquid of the emulsion is caused to evaporate from the coating composition.

### DETAILED DESCRIPTION

### Proppant Particle Substrate

As indicated above, the self-suspending proppants which are made humidity-resistant in accordance with this invention take the form of a proppant particle substrate carrying a coating of a hydrogel-forming polymer.

For this purpose, any particulate solid which has previously been used or may be used in the future as a proppant in connection with the recovery of oil, natural gas and/or natural gas liquids from geological formations can be used as the proppant particle substrate of the improved self-suspending proppants of this invention. In this regard, see our earlier filed applications mentioned above which identify many different particulate materials which can be used for this purpose. As described there, these materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and 4.7 g/cc and more.

Specific examples include graded sand, resin coated sand including sands coated with curable resins as well as sands coated with precured resins, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8-2.0 g/cc), normal frac sand (density ˜2.65 g/cc), bauxite and high density ceramics (density ˜5 g/cc), just to name a few. Resin-coated versions of these proppants, and in particular resin-coated conventional frac sand, are also good examples.

All of these particulate materials, as well as any other particulate material which is used as a proppant in the future, can be used as the proppant particle substrate in making the humidity-resistant self-suspending proppants of this invention.

### Hydrogel Coating

In order to make the humidity-resistant proppants of this invention self-suspending, the above proppant particle substrates are provided with a coating of a hydrogel-forming polymer in such a way that
(1) the inventive proppants rapidly swell when contacted with their aqueous fracturing fluids,
(2) the inventive proppants form hydrogel coatings which are large enough to significantly increase their buoyancy during transport downhole, thereby making these proppants self-suspending during this period, and
(3) these hydrogel coatings are also durable enough to remain substantially intact until these proppants reach their ultimate use locations downhole,
   In this context, “self-suspending” means that a proppant requires a lower viscosity fluid to prevent it from settling out of suspension than would otherwise be the case. In addition, “substantially intact” means that the hydrogel coating is not substantially dislodged prior to the proppant reaching its ultimate use location downhole.

Our prior applications mentioned above describe in detail how this can be done. To summarize, the following practices can be observed: To achieve hydrogel coatings which are large enough to significantly increase the buoyancy of these modified proppants in their aqueous fracturing fluids, hydrogel-forming polymers are selected which are capable of taking up (i.e., forming a gel from) 10 to 1000 times their weight in water or even more. Hydrogel-forming polymers which are capable of taking up at least 50 times, at least 100 times, at least 300 times, at least 500 times, at least 800 times, at least 900 times, or at least 1000 times their weight in water are particularly interesting.

In addition, the amount of such hydrogel-forming polymer (on a dry solids basis) which is applied to the proppant particle substrate will generally be between about 0.1-10 wt. %, based on the weight of the proppant particle substrate. More commonly, the amount of hydrogel-forming polymer which is applied will generally be between about 0.5-5 wt. %, based on the weight of the proppant particle substrate. Within these broad ranges, polymer loadings of <5 wt. %, ≦4 wt. %, ≦3 wt. %, ≦2 wt. %, and even ≦1.5 wt. %, are interesting.

By adopting these approaches, the modified proppants of this invention, once hydrated, achieve an effective volumetric expansion which makes them more buoyant and hence effectively self-suspending within the meaning of this disclosure. In addition, they are also “slicker” than would otherwise be the case in that they flow more easily through the pipes and fractures through which they are transported. As a result, they can be driven farther into a given fracture than would otherwise be the case for a given pumping horsepower. Surprisingly, this advantageous result occurs even though the volumetric expansion these modified proppants exhibit is small.

In any event, the types and amounts of hydrogel-forming polymer which are applied to the proppant particle substrates of this invention will generally be sufficient so that the volumetric expansion of the inventive proppants, as determined by the Settled Bed Height Analytical test described below and in our earlier applications, is desirably ≧˜1.5, ≧˜3, ≧˜5, ≧˜7, ≧˜8, ≧˜10, ≧˜11, ≧˜15, ≧˜17, or even ≧˜28. Of course, there is a practical maximum to the volumetric expansion the inventive proppants can achieve, which will be determined by the particular type and amount of hydrogel-forming polymer used in each application.

The Settled Bed Height Analytical Test mentioned above can be carried out in the following manner: In a 20 mL glass vial, 1 g of the dry modified proppant to be tested is added to 10 g of water (e.g., tap water) at approximately 20° C. The vial is then agitated for about 1 minute (e.g., by inverting the vial repeatedly) to wet the modified proppant coating. The vial is then allowed to sit, undisturbed, until the hydrogel polymer coating has become hydrated. The height of the bed formed by the hydrated modified proppant can be measured using a digital caliper. This bed height is then divided by the height of the bed formed by the dry proppant. The number obtained indicates the factor (multiple) of the volumetric expansion. Also, for convenience, the height of the bed formed by the hydrated modified proppant can be compared with the height of a bed formed by uncoated proppant, as the volume of uncoated proppant is virtually the same as the volume of a modified proppant carrying a hydrogel coating, when dry.

A second feature of the hydrogel coatings of the inventive proppants is that they rapidly swell when contacted with water. In this context, “rapid swelling” will be understood to mean that the significant increase in buoyancy the inventive proppants exhibit as a result of these coatings is achieved at least by the time these modified proppants, having been mixed with their aqueous fracturing liquids and charged downhole, reach the bottom of the vertical well into which they have been charged such as occurs, for example, when they change their direction of travel from essentially vertical to essentially horizontal in a horizontally drilled well. More typically, these coatings will achieve this substantial increase in buoyancy within 30 minutes, within 10 minutes, within 5 minutes, within 2 minutes or even within 1 minute of being combined with their aqueous fracturing liquids. As indicated above, this generally means that hydration of the hydrogel-forming polymers used will be essentially complete within 2 hours, or within 1 hour, or within 30 minutes, or within 10 minutes, or within 5 minutes, or within 2 minutes or even within 1 minute of being combined with an excess of water at 20° C. As further indicated above “essentially complete” hydration in this context means that the amount of volume increase which is experienced by the inventive modified proppant is at least 80% of its ultimate volume increase.

To achieve hydrogel coatings which exhibit this rapid swelling, two separate approaches are normally followed. First, only those hydrogel polymers which are capable of swelling this rapidly are selected for use in this invention. Normally this means that the hydrogel-forming polymers described in our earlier applications will normally be used, these polymers including polyacrylamide, hydrolyzed polyacrylamide, copolymers of acrylamide with ethylenically unsaturated ionic comonomers, copolymers of acrylamide and acrylic acid salts, poly(acrylic acid) or salts thereof, carboxymethyl cellulose, hydroxyethyl cellulose, hydroxypropyl cellulose, guar gum, carboxymethyl guar, carboxymethyl hydroxypropyl guar gum, hydrophobically associating swellable emulsion polymers, etc. Other hydrogel-forming polymers exhibiting similar swelling properties can also be used.

Second, any compounding or treatment of these hydrogel-forming polymers which would prevent these polymers from exhibiting these swelling properties, whether applied during or after coating, is avoided. So, for example, the surface crosslinking procedure described in U.S. 2008/0108524 to Willburg et al., which prevents the coated proppants described there from swelling until they reach their ultimate use location downhole, is avoided when the inventive proppants are made, since this approach would prevent the inventive proppants from being self-suspending while being transported downhole. In the same way, including excessive amounts of crosslinking agents in these hydrogel-forming polymers is also avoided, since this would also prevent the inventive proppants from being self-suspending.

This is not to say that crosslinking of the hydrogel coatings of the inventive proppants must be avoided altogether. On the contrary, crosslinking and other treatments of these hydrogel coatings are entirely appropriate so long as they are carried out in a manner which does not prevent the hydrogel coatings ultimately obtained from exhibiting their desirable swelling properties, as mentioned above. To this end, see Examples 6-8 in our earlier applications which describe particular examples of self-suspending proppants in which the hydrogel coating has been surface crosslinked in a manner which still enables their desired swelling properties to be achieved.

A third feature of the hydrogel coatings of our self-suspending proppants is that they are durable in the sense of remaining largely intact until these modified proppants reach their ultimate use locations downhole. In other words, these hydrogel coatings are not substantially dislodged prior to the modified proppants reaching their ultimate use locations downhole.

In this regard, it will be appreciated that proppants inherently experience significant mechanical stress when they are used, not only from pumps which charge fracturing liquids containing these proppants downhole but also from overcoming the inherent resistance to flow encountered downhole due to friction, mechanical obstructions, sudden changes in direction, etc. The hydrogel coatings of our self-suspending proppants, although inherently fragile due to their hydrogel nature, nonetheless are durable enough to resist these mechanical stresses and hence remain largely intact (or at least associated with the substrate) until they reach their ultimate use locations downhole.

As indicated in our earlier applications, coating durability can be measured by a Shear Analytical Test described in which the proppants are sheared at about 550 s for 20 minutes. (For hydrogel-forming polymers which take more than 20 minutes to hydrate, longer shear times can be used.) A hydrogel coating is considered durable if the settled bed height of the proppant after being subjected to this shearing regimen, when compared to the settled bed height of another sample of the same proppant which has not be subjected to this shearing regimen, (“shearing ratio”) is at least 0.2. Modified proppants exhibiting shearing ratios of >0.2, ≧0.3, ≧0.4, ≧0.5, ≧0.6, ≧0.7, ≧0.8, or ≧0.9 are desirable. In some instances, the modified proppants can exhibit shearing ratios of >1.0 as the hydrogel can continue to expand upon continued shearing.

In addition to shearing ratio, another means for determining coating durability is to measure the viscosity of the supernatant liquid that is produced by the above Shear Analytical Test after the proppant has had a chance to settle. If the durability of a particular proppant is insufficient, an excessive amount of its hydrogel polymer coating will become dislodged and remain in the supernatant liquid. The extent to which the viscosity of this liquid increases is a measure of the durability of the hydrogel coating. A viscosity of about 20 cps or more when a 100 g sample of modified proppant is mixed with 1 L of water in the above Shear Analytical test indicates a low coating durability. Desirably, the viscosity of the supernatant liquid will be about 10 cps or less, more desirably about 5 cps or less.

To achieve hydrogel coatings which exhibit the desired degree of durability, a number of approaches can be used. First, hydrogel-forming polymers having desirably high molecular weights can be used. As indicated in our earlier applications, the hydrogel coatings of our self-suspending proppants desirably form a “cage” which wholly surrounds and encapsulates the proppant particle substrate. The individual molecules of these hydrogel-forming polymers can be viewed as functioning like miniature “ropes” or “strings” that entangle themselves with one another, thereby forming a continuous network of polymer chains extending around the surface of the proppant particle substrate on which they are coated. The amount of this intermolecular entangling, as well as the distance these individual molecules extend along the surface of the proppant particle substrate, increase as the lengths of these polymer chains increases. Accordingly, hydrogel polymers with larger molecular weights are desirably used, as the molecules forming these polymers are inherently longer.

To this end, the weight average molecular weights of the hydrogel-forming polymers used to make our self-suspending proppants are normally at least 1 million Daltons, as previously indicated. More desirably, the weight average molecular weights of these polymers is ≧2.5 million, ≧5 million, ≧0.7.5 million, or even ≧10 million Daltons. Hydrogel polymers having weight average molecular weights of ≧12.5 million, ≧15 million, ≧17.5 million and even ≧20 million Daltons are particularly interesting.

A second approach that can be used to achieve hydrogel coatings exhibiting durability is to adopt a chemistry which allows at least some chemical bonding to occur between the proppant particle substrate and its hydrogel coating. In a number of embodiments of this invention, raw frac sand (i.e., frac sand whose surfaces have not been coated or treated with any other material) is coated with a hydrogel-forming polymer which is an acrylamide copolymer. Such polymers contain pendant amide groups which are capable of forming weak bonds (e.g., hydrogen bonding, Van der Waals attractions, etc.) with the pendant hydroxyl groups present on the surfaces of the raw frac sand. Anionic acrylamide copolymers further contain pendant carboxylate groups which are also are capable of forming these weak bonds. These weak bonding associations can effectively increase the bond strength of the hydrogel coating, especially when the hydrogel polymers used have larger molecular weights.

In a similar way, hydrogel-forming polymers which are cellulose based, as well as certain naturally-occurring hydrogel-forming polymers, can also form coatings with enhanced bond strengths, as these polymers typically include significant amounts of pendant hydroxyl groups. These pendant hydroxyl groups and the pendant hydroxyl groups present on the surfaces of the raw frac sand are capable of undergoing hydrogen bonding, the result of which is an improvement in the bond strength formed between these polymers and their underlying proppant particle substrates.

In this regard, note that the improved bond strengths which are achieved by these approaches are due, at least in part, to the fact that the inventive proppants when made from these materials are heated to cause drying before these proppants are used. In order for hydrogen bonding and the other bonding mechanisms contemplated above to occur, heating to a suitable activation temperature is normally required. Accordingly, when hydrogen bonding and similar bonding approaches are relied on for improving bond strength, the inventive proppants are desirably heated to drying before they are used, because this ensures that these bonding associations will occur.

Another approach that can be used for chemically enhancing the bond strength between the hydrogel coating and its proppant particle substrate is to pretreat the proppant particle substrate with an appropriate chemical agent for increasing bond strength. For example, the proppant particle substrate can be pretreated with a cationic polymer such as PDAC, poly-DADMAC, LPEI, BPEI, chitosan, and cationic polyacrylamide as described in our earlier applications mentioned above, particularly in Examples 1-4 and 9 of these applications. Similarly, silane coupling agents of all different types can be used to impart chemical functionality to raw frac sand for enhancing the bond strength of hydrogel-forming polymers containing complementary functional groups, as also discussed in these earlier applications. In addition, other chemical treatments can be used such as illustrated in Examples 46-54 in our earlier application Ser. No. 13/838,806.

A third approach that can be used to achieve hydrogel coatings which exhibit the desired degree of durability is to include a coalescing agent in the coating composition used to form the hydrogel coated proppants. For example, as described in connection with FIGS. 4a, 4b and 5 and confirmed by Examples 13 and 19 of our earlier applications, including glycerol in the hydrogel-forming polymer coating composition described there substantially increases the uniformity and coherency of the hydrogel coating obtained which, in turn, substantially increases its durability. Similar glycols, polyols and other agents which promote coalescence of the hydrogel-forming polymer can also be used.

A fourth approach that can be used to increase bond strength is to form the hydrogel coating by in situ polymerization, as further discussed and exemplified in our earlier application Ser. No. 13/838,806, especially in Example 16.

As can therefore be appreciated, by following the various approaches summarized above, it is possible to produce modified proppants which rapidly swell when contacted with their aqueous fracturing fluids to form proppants which become and remain self-suspending until they reach their ultimate use locations downhole.

### Improved Humidity Resistance

In accordance with the invention of this disclosure, the self-suspending proppants generally described in our earlier applications can be made more humidity resistant when dry by including in the coating compositions used to form the hydrogel coatings of these proppants (1) an organofunctional compound comprising at least one polyol, at least one polyamine or both and (2) a covalent crosslinking agent for the hydrogel polymer which is also capable of chemically reacting with this organofunctional compound.

In this context, “more humidity resistant when dry” will be understood to mean that the inventive humidity-resistant self-suspending proppants, prior to being combined with their aqueous fracturing fluids, resist caking and/or agglomeration when exposed to high humidity conditions over extended periods of time to a greater extent than otherwise identical self-suspending proppants not formulated in accordance with this invention. Preferably, the inventive humidity-resistant self-suspending proppants remain free-flowing after being subjected to a relative humidity of between about 80%-90% for one hour at 25-35° C. In this context, a proppant will be considered “free-flowing” if any clumping or agglomeration it may experience can be broken up by gentle agitation.

As indicated above, the feature of including a polyol coalescing agent in the coating compositions used to form our self-suspending proppants is already described in our earlier applications. In addition, the feature of including crosslinking agents in these coating compositions is also described in our earlier applications. In accordance with this invention, we have found that if both of these features are used together, self-suspending proppants can be obtained which exhibit superior humidity resistance when dry provided that the crosslinking agent used is a covalent crosslinking agent which is also capable of chemically reacting with this polyol coalescing agent. Furthermore, we have also found that this same improvement in humidity resistance can also be achieved if other polyols, as well as polyamines, are used together with, or in lieu of, the particular polyol coalescing agents described in our earlier applications.

The polyols that can be used to make the inventive humidity-resistant self-suspending proppants of this disclosure are any polyol containing two or more pendant hydroxyl groups. Both monomeric polyols such as glycerin, pentaerythritol, ethylene glycol and sucrose can be used, as can polymeric polyols such as polyester polyols and polyether polyols such as polyethylene glycol, polypropylene glycol, and poly(tetramethylene ether) glycol.

In embodiments, these polyols have molecular weights which are low enough to dissolve in any carrier liquid that may be present in the coating compositions used to form our self-suspending proppants. For example, these polyols can have molecular weights which are low enough to be liquid at room temperature, i.e., 20° C. These polyols may contain 2-15 carbon atoms, more typically 2-10, or even 2-8, carbon atoms and 2-5, more typically 3-5, pendant hydroxyl groups. Liquid polyol having 3-6 carbon atoms and 2-4 pendant hydroxyl groups are especially interesting, as are liquid polyols having 3-6 carbon atoms and 3-5 pendant hydroxyl groups. Particular examples of liquid polyols which are useful for this invention include ethylene glycol, propylene glycol, butylene glycol, pentylene glycol, glycerol, trihydroxy butane and trihydroxy pentane.

In the same way, the polyamines that can be used to make the inventive humidity-resistant self-suspending proppants of this disclosure are any polyamine containing two or more primary amino groups, i.e., (—NH₂). Both monomeric polyamines such as ethylene diamine, 1,3-diaminopropane and hexametylenediamine can be used, as well as polymeric polyamines such as polyethyleneimine. These polyamines my also have molecular weights which are low enough to dissolve in the carrier liquids of the coating compositions and may also be liquids at room temperature, i.e., 20° C. These polyamines also may contain 2-15 carbon atoms, more typically 2-10, or even 2-8, carbon atoms and 2-5, more typically 3-5, primary amino groups. Liquid polyamines having 3-6 carbon atoms are interesting.

The covalent crosslinking agents that can be used to make the inventive humidity-resistant self-suspending proppants include any multi-functional organic compound capable of chemically reacting with the polyol and/or polyamine organofunctional compound included in the coating composition as well as the hydrogel-forming polymer used to make the inventive proppants. Thus, this organic compound may be a simple organic compound in the sense of being non-polymeric or it may be oligomeric or polymeric.

Essentially any organic compound having two or more functional groups can be used for this purpose, provided that at least one of these functional groups is capable of reacting with the pendant hydroxyl groups of the polyol and/or the primary amino groups of the polyamine, as the case may be, and further provided that at least another of these functional groups is capable of reacting with a functional group present in the hydrogel-forming polymer used to make the inventive proppants.

In this regard, it is believed that the inventive self-suspending proppants are more humidity resistant when dry because, as these proppants are being made, the covalent crosslinking agent in addition to reacting with and thereby crosslinking the hydrogel-forming polymer also reacts with at least some of the polyol and/or polyamine organofunctional compound, thereby incorporating at least some of this organofunctional compound into the weak, pervious, protective shell or web which is formed by the crosslinking reaction.

This weak, pervious, protective shell can be viewed as acting like an elastic net in the sense that, when the inventive proppant is dry, this weak elastic net prevents any significant swelling and hence softening of the very surface of the hydrogel-forming polymer in response to atmospheric moisture. As a result, the individual proppant particles are prevented from getting too sticky and hence clumping or caking together when dry, even if they are exposed to significant atmospheric moisture. On the other hand, when the inventive proppant is wet (i.e., when it is exposed to its aqueous fracturing fluid), this elastic net is open enough to allow rapid and essentially complete hydration of its hydrogel polymer coating. In addition, it is elastic enough to allow this hydrated polymer layer to swell substantially, thereby still enabling these proppants to become self-suspending.

It will therefore be appreciated that the improved performance exhibited by the inventive self-suspending proppants is due, at least in part, to the fact that the polyol and/or polyamine organofunctional compound which is included in the coating composition becomes chemically incorporated into the crosslinked structure which is formed by the crosslinking reaction. Moreover, in those embodiments in which the particular organofunctional compound used is a polyol coalescing agent, a dual benefit is achieved in that not only is this polyol chemically incorporated into this crosslinked structure but in addition film formation of the hydrogel coating during proppant manufacture is facilitated.

In this regard, it should appreciated that the different ingredients in the coating compositions of this invention which contain amide, hydroxyl and primary amino groups, e.g., the hydrogel-forming polymer, the polyol and/or polyamine organofunctional compound, water and the optional polysaccharides further discussed below, may react with the covalent crosslinking agent at different reaction rates. For example, in some of the following working examples, pMDI is used to crosslink an anionic polyacrylamide in an aqueous coating composition containing glycerol as the liquid polyol coalescing agent. It is believed that the reaction rate of pMDI with the pendant amide groups of the polyacrylamide is faster than the reaction rate of the pMDI with the pendant hydroxyl groups of the glycerol, which in turn is faster than the reaction rate of the pMDI with water.

As a result, it is likely that the pMDI covalent crosslinking agent preferentially reacts with the polyacrylamide in this system. This, in turn, means that is unclear exactly how much of the glycerol in this system actually reacts with the pMDI so as to become chemically incorporated into the crosslinked structure forming the weak, pervious, protective shell of this invention.

Nonetheless, we have found that the inventive self-suspending proppants exhibit improved properties in terms of being free flowing when dry, even though we are unable determine how much of this polyol becomes chemically incorporated into the crosslinked shell formed by the polyacrylamide. Accordingly, we conclude that at least some of this polyol is chemically incorporated into this crosslinked shell, since this would explain why these improved properties are achieved.

Finally, it will always be possible to insure that at least some of the polyol and/or polyamine organofunctional compound is chemically incorporated into the crosslinked shell formed by the hydrogel-forming polymer by (1) selecting a covalent crosslinking agent that is reactive with pendant hydroxyls and/or primary amino groups of these compounds and (2) using a sufficient amount of this covalent crosslinking agent.

Particular covalent crosslinking agents that can be used to make the inventive humidity and calcium ion-resistant self-suspending proppants include all of the covalent crosslinking agents mentioned in our earlier applications mentioned above. So, for example, organic compounds containing at least two of the following functional groups can be used: epoxides, anhydrides, aldehydes, diisocyanates, carbodiamides, divinyl, or diallyl groups. Particular examples of these covalent crosslinkers include: PEG diglycidyl ether, epichlorohydrin, maleic anhydride, formaldehyde, glyoxal, glutaraldehyde, toluene diisocyanate, methylene diphenyl diisocyanate, 1-ethyl-3-(3-dimethylaminopropyl) carbodiamide, methylene bis acrylamide, and the like.

Especially interesting are the diisocyanates such as toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

In addition to these diisocyanates, analogous polyisocyanates having three or more pendant isocyantes can also be used. In this regard, it is well understood in the art that the above and similar diisocyanates are commercially available both in monomeric form as well as in what is referred to in industry as “polymeric” form in which each diisocyante molecule is actually made up from approximately 2-10 repeating isocyante monomer units.

For example, MDI is the standard abbreviation for the particular organic chemical identified as diphenylmethane diisocyanate, methylene bisphenyl isocyanate, methylene diphenyl diisocyanate, methylene bis (p-phenyl isocyanate), isocyanic acid: p,p′-methylene diphenyl diester; isocyanic acid: methylene dip-phenylene ester; and 1,1′-methylene his (isocyanato benzene), all of which refer to the same compound. MDI is available in monomeric form (“MMDI”) as well as “polymeric” form (“p-MDI” or “PMDI”), which typically contains about 30-70% MMDI with the balance being higher-molecular-weight oligomers and isomers typically containing 2-5 methylphenylisocyanate moieties.

For the purposes of this disclosure, it will be understood that we use “diisocyanate” in the same way as in industry to refer to both monomeric diisocyanates and polymeric isocyanates, even though these polymeric isocyanates necessarily contain more than two pendant isocyanate groups. Correspondingly, where we intend to refer to a simple monomeric diisocyanate, “monomeric” or “M” will be used such as in the designations “MMDI” and “monomeric MDI.” In any event, it will be understood that for the purposes of this invention, all such diisocyanates can be used as the covalent crosslinking agent, whether in monomeric form or polymeric form.

In addition to these diisocyanates, additional polyisocyanate-functional compounds that can be used as the covalent crosslinking agents of this invention are the isocyanate-terminated polyurethane prepolymers, such as the prepolymers obtained by reacting toluene diisocyanate with polytetramethylene glycols. Isocyanate terminated hydrophilic polyurethane prepolymers such as those derived from polyether polyurethanes, polyester polyurethanes as well as polycarbonate polyurethanes, can also be used.

In this regard, it is desirable when making the inventive humidity-resistant self-suspending proppant that the covalent crosslinking agents be in liquid form when combined with the other ingredients of the coating compositions. This is because this approach enhances the uniformity with which this crosslinking agent is distributed in the coating composition and hence the uniformity of the crosslinked layer or “shell” that is ultimately produced.

For this purpose, particular crosslinking agents can be selected which are already liquid in form. For example, MMDI, pMDI and other analogous diisocyanates can be used as is, as they are liquid in form as received from the manufacturer. Additionally or alternatively, the crosslinking agent can be dissolved in a suitable organic solvent. For example, many aliphatic diisocyanates and polyisocyanates are soluble in toluene, acetone and methyl ethyl ketone, while many aromatic diisocyanates and polyisocyanates are soluble in toluene, benzene, xylene, low molecular weight hydrocarbons, etc. Dissolving the isocyanate in an organic solvent may be very helpful, for example, when polymeric and other higher molecular weight diisocyanates are used.

In particular embodiments of this invention, (1) the hydrogel-forming polymer used to make the inventive self-suspending proppants will be formed from an acrylamide polymer or copolymer and in particular an anionic polyacrylamide, i.e., a copolymer of acrylamide and at least one other anionic monomer such as acrylic acid, sodium acrylate, ammonium acrylate, acrylamidomethylpropane sulfonic acid (AMPS), the sodium salt of AMPS (NaAMPS), etc., while (2) the organofunctional compound is a polyol, and especially a polyol coalescing agent. In these embodiments, diisocyanates and polyisocyanates make especially desirable covalent crosslinking agents, since they readily react with the amide groups of the acrylamide moieties of these polymers and copolymers as well as the hydroxyl groups of the polyol also in the system.

### Catalyst for Cross-Linking Agent

In accordance with another feature of this invention, a catalyst (also referred to as an “accelerator”) can be included in the coating composition to facilitate the reaction of the covalent crosslinking agent with the hydrogel-forming polymer, the polyol and/or polyamine organofunctional compound and any other reactive chemical specie that may also be included in the composition.

Common types of catalysts or accelerators for many crosslinking agents include acids such as different sulfonic acids and acid phosphates, tertiary amines such as triethylenediamine (also known as 1,4-diazabicyclo[2.2.2]octane), and metal compounds such as lithium aluminum hydride and organotin, organozirconate and organotitanate compounds. Examples of commercially available catalysts include Tyzor product line (Dorf Ketal); NACURE, K-KURE and K-KAT product lines (King Industries); JEFFCAT product line (Huntsman Corporation) etc. Any and all of these catalysts can be used to accelerate the crosslinking reaction occurring in the inventive technology.

### Cationic Hydrogel Polymers

It is well known that calcium and other similar ions can substantially retard the ability of hydrogel-forming polymers, especially anionic hydrogel-forming polymers, to swell when contacted with water. This problem can be particularly troublesome when such polymers are used in hydraulic fracturing applications, because the ground water used to make up the aqueous fracturing fluids often contain significant quantities of these ions. To this end, the self-suspending proppants of our earlier disclosures can also be adversely affected by these ions, as reflected by a reduction in the degree to which these proppants swell and hence the degree to which they become self-suspending when contacted with their aqueous fracturing fluids

In accordance with another feature of this invention, we have found that the tendency of calcium and other similar ions to adversely affect the swelling properties of our self-suspending proppants can also be lessened significantly by selecting a cationic polymer such as a cationic polyacrylamide as the hydrogel-forming polymer for use in making these proppants. In this context, it will be understood that “cationic polyacrylamide” and “anionic polyacrylamide” refer to copolymers of acrylamide with other monomers which introduce cationic or anionic functionality into the copolymer, as the case may be.

As compared with their anionic polyacrylamide counterparts, cationic polyacrylamides, are less impacted by the presence of calcium/magnesium ions, since they do not have anionic charges. Accordingly, self-suspending proppants exhibiting especially good calcium ion-resistance can be made in accordance with this invention by selecting a cationic polyacrylamide as the hydrogel-forming polymer.

### Method of Manufacture

As can be seen from our earlier applications, the most convenient way of making our self-suspending proppants is by combining the proppant particle substrate to be coated with an emulsion of the hydrogel-forming polymer followed by causing the water and any other carrier liquid that might be present to evaporate. In this context, “emulsion” will be understood to include invert emulsions or suspensions in which water droplets containing the hydrogel-forming polymer are emulsified or suspended in an organic liquid. In addition, “causing” the liquid to evaporate will also be understood as including situations in which the carrier liquid is allowed to evaporate on its own.

This emulsion coating technique is convenient because the emulsions used for this purpose are readily available, commercially, in a wide variety of different choices at reasonable cost. Moreover, the hydrogel-forming polymers in these emulsions normally have fairly well-defined molecular weights, especially in the higher molecular weight ranges, which is advantageous in connection with making our self-suspending proppants, as discussed above. For the same reasons, the most convenient way of making the humidity-resistant self-suspending proppants of this invention will also be by this same approach.

When making the inventive proppants in this way, the covalent crosslinking agent can be combined with the hydrogel-forming polymer and the polyol and/or polyamine organofunctional compound at essentially any time that will enable both the hydrogel-forming polymer and the organofunctional compound to be crosslinked together by this crosslinking agent. For example, the covalent crosslinking agent can be added to the coating composition before the hydrogel-forming polymer and organofunctional compound are added or at the same time these ingredients are added. If so, these ingredients are preferably added at the same time, or within a short time of one another, so that the covalent crosslinking agent can react with both the hydrogel-forming polymer and the organofunctional compound together rather than substantially reacting with one before beginning to react with the other.

Normally, however, the covalent crosslinking agent will be added after the hydrogel-forming polymer and organofunctional compound are added, as this insures that both of these ingredients are available for crosslinking as soon as the crosslinking agent is added. In addition, it also enables a hydrogel coating to begin forming on the proppant particle substrate without interference from the covalent crosslinking agent. As a result, the bond that forms between this coating and substrate is not affected by the covalent crosslinking agent. In addition, the location of crosslinking is focused towards the surface of the coating, which promotes formation of a crosslinked shell or web in the manner discussed above.

While the most convenient way of making the inventive humidity-resistant self-suspending proppants will be the emulsion coating approach mentioned above, any other approach which will provide the substrate with a coating of a hydrogel-forming polymer and a covalent crosslinking agent can be employed.

### Ingredient Proportions

As indicated above, the self-suspending proppants described here and in our earlier applications are made in such a way that they rapidly swell when contacted with their aqueous fracturing fluids to form hydrogel coatings which substantially increase the buoyancy of these proppants during their transport downhole yet are durable enough to remain largely intact until they reach their ultimate use locations downhole. As further indicated above, the inventive self-suspending proppants described here are further formulated to include a weak, pervious, protective layer or shell which enhances the humidity-resistance of these proppants. To this end, it will be appreciated that there can be an inherent trade-off among these features in that achieving rapid swelling and substantial increase in buoyancy, on the one hand, and achieving durability and humidity resistance, on the other hand, can be opposed to one another.

So for example, if a particular hydrogel-coated proppant is made to achieve a high level of durability and humidity resistance, the ability of its hydrogel coating to swell rapidly and substantially may be compromised to the extent that it will no longer be self-suspending. In contrast, if a particular hydrogel-coated proppant is made to swell very rapidly and substantially for self-suspending purposes, its hydrogel coating may be too hygroscopic to prevent substantial caking and agglomeration when exposed to high humidity conditions and too weak to remain intact when exposed to shear downhole.

It will therefore be appreciated that, in producing the inventive humidity-resistant self-suspending proppants, care must be taken to use amounts of polyol/polyamine organofunctional compound and covalent crosslinking agent which are enough to achieve a desired level of durability and humidity resistance yet not so much that these proppants are prevented from swelling rapidly and substantially enough to make them self-suspending. To this end, it is desirable that the amounts of these ingredients used be such that the volumetric expansion of these proppants, as determined by the Settled Bed Height Analytical test described above, is ≧˜1.5, more desirably ≧˜3, ≧˜5, ≧˜7, ≧˜8, ≧˜10, ≧˜11, ≧˜15, ≧˜17, or even ≧˜28.

In this regard, the amount of hydrogel-forming polymer that can be used to form the humidity-resistant self-suspending proppants of this invention can be generally the same as mentioned above in connection with earlier versions of our self-suspending proppants, i.e., about 0.1-10 wt. % hydrogel-forming polymer (on a dry solids basis), based on the weight of the proppant particle substrate. More commonly, the amount of hydrogel-forming polymer will be about 0.5-5 wt. % on this basis, with amounts in this range of ≦5 wt. %, ≦4 wt. %, ≦3 wt. %, ≦2 wt. %, and even ≦1.5 wt. %, being interesting.

Similarly, the amount of polyol and/or polyamine organofunctional compound that can be used to form the inventive self-suspending proppants can also be generally the same as disclosed in our earlier applications in connection with using alcohol coalescing agents, i.e., about 0.3 wt. % based on the weight of the proppant particle substrate. However, amounts as small as 0.1 wt. % and as much as 3 wt. % can be used, if desired. Amounts ranging from 0.15-1.0 wt. % and even 0.2-0.5 wt. %, based on the weight of the proppant particle substrate, are more common. In terms of the relative amount of polyol and/or polyamine organofunctional compound relative to the hydrogel-forming polymer, the weight ratio of polymer to organofunctional compound will normally be about 10:1 to 1:1, more commonly 5:1 to 2:1 or even 4:1 to 2.5:1, on a weight basis.

Meanwhile, the amount of covalent crosslinking agent that can be used to form the inventive self-suspending proppants can vary widely and depends primarily on its molecular weight and the “density” of its functional groups, i.e., the number of functional groups per unit of molecular weight. In this regard, it will be understood that a greater amount of an isocyanate-terminated polyurethane prepolymer would be needed to provide a given amount of crosslinking than pMDI or MMDI, for example, since these diisocyanates have more isocyanate groups on a molecular weight basis than such a polyurethane prepolymer.

Against that background, we can say that the amount of conventional (i.e., non-prepolymer) covalent crosslinking agents that can be used generally will range between about 0.05 and 1.0 wt. %, based on the weight of the proppant particle substrate, although amounts as high 2.0 wt. % or even more can be used especially for crosslinking agents with higher molecular weights. Amounts 0.1 to 0.8, 0.15 to 0.6, and even 0.2 to 0.5, wt. % based on the weight of the proppant particle substrate will be more common. In terms of the relative amount of these covalent crosslinking agents, the weight ratio of these crosslinking agents to hydrogel-forming polymer can be about 0.05:1 to 1.2:1, more commonly about 0.25:1 to 0.8:1, or even 0.3:1 to 0.7:1, while the weight ratio of these crosslinking agents to polyol and/or polyamine organofunctional compound will normally be about 0.4:1 to 4:1, more commonly about 0.7:1 to 2.5:1, or even 0.8 to 2:1.

As indicated above, care must be taken in implementing particular embodiments of this invention to use amounts of covalent crosslinking agent which are enough to achieve the desired level of durability and humidity resistance yet not so much that the proppants obtained are not self-suspending. To achieve this result on a consistent basis, the approach shown in the following Example 2 can be taken in which the appropriate amount of covalent crosslinking agent is determined by routine experimentation in which a number of test proppants are made with varying amounts of covalent crosslinking agent. Those test proppants exhibiting the appropriate combination of hydrogel swelling and buoyancy, on the one hand, and durability and humidity resistance on the other hand, will inform the appropriate amount of covalent crosslinking agent to use.

Finally, if a catalyst or accelerator for the covalent crosslinking agent is used, it should be included in the coating compositions in amounts sufficient to increase the rate and/or extent of curing of the hydrogel-forming polymer coating. For example, when pMDI is used as the covalent crosslinking agent and the tertiary amine (bis(3-dimethylaminopropyl)-n,n-dimethylpropanediamine) is used as the catalyst, the weight ratio of catalyst to covalent crosslinking agent can range from about 0.02:1 to 0.5:1, more commonly 0.05:1 to 0.30:1 or even 0.10:1 to 0.22:1. Corresponding amounts of other catalysts can be used, taking into accounts differences in molecular weights, etc.

### Polysaccharide Augmentation

In accordance with still another feature of this invention, a small but suitable amount of a polysaccharide is included in the coating composition used to form the inventive self-suspending proppants. In accordance with this feature, we have found that the humidity resistance of these proppants can be enhanced even further by following this approach. Although not wishing to be bound to any theory, we believe the reason for this result is that at least some of this polysaccharide becomes included in the weak, pervious, protective shell that is formed upon crosslinking as a result of reaction between the covalent crosslinking agent and pendant hydroxyl groups on the polysaccharide.

Essentially any polysaccharide can be used for this purpose. Particular examples include dextrin, maltodextrin, carboxymethyl cellulose, hydroxyethyl cellulose, hydroxypropyl cellulose, guar gum, carboxymethyl guar and carboxymethyl hydroxypropyl guar gum.

The amount of polysaccharide that can be added for this purpose can vary widely, and essentially any amount can be used. For example, amounts as little as 0.01 wt % to as much as 2 wt. %, based on the weight of proppant particle substrate, can be used. More typically, about 0.05 to 0.5 wt. %, or even about 0.1 to 0.25 wt %, polysaccharide based on the weight of the proppant particle substrate can be used. In terms of ingredient proportions, the weight ratio of the polysaccharide to the hydrogel-forming polymer can be about 0.05:1 to 0.6:1, more typically about 0.1:1 to 0.3:1 or even about 0.15:1 to 0.2:1. Similarly, the weight ratio of the polysaccharide to the polyol and/or polyamine organofunctional compound can be about 0.1: to 1:1, more typically about 0.2:1 to 0.75:1, or even about 0.4:1 to 0.6:1. Meanwhile, the weight ratio of the polysaccharide to the covalent crosslinking agent can be about 0.2:1 to 1.5:1, more typically about 0.3:1 to 1.3:1 or even about 0.5:1 to 1:1. Finally, the weight ratio of the polysaccharide to the catalyst that is used, if any, can be about 1:1 to 15:1, more typically about 3:1 to 10:1 or even about 4:1 to 6:1.

If a polysaccharide coating augmenter is used in accordance with this feature of the invention, it can be added to the coating composition used to make the inventive self-suspending proppants at essentially any time. Of course, care should be taken to avoid combining this reactant with the covalent crosslinking agent in the system in a manner which would cause premature reaction of this crosslinking agent with the polysaccharide. In one especially convenient approach, this polysaccharide coating augmenter can be combined with the optional catalyst for the covalent crosslinking agent, and the mixture so formed then added to the coating composition either before or after this crosslinking agent is added.

### EXAMPLES

In order to describe this invention more thoroughly, the following working examples are provided.

### Example 1

500 g of 30/50 mesh sand was added to a Hobart-type mixer along with 13.5 g of a commercially-available anionic polyacrylamide invert emulsion containing approximately equal amounts of a high molecular weight hydrogel-forming anionic polyacrylamide copolymer, water and a hydrocarbon carrier liquid. 1.5 g glycerol was also added, making the weight ratio of hydrogel forming polymer to glycerol in the compositions about 3:1. The mixture was then stirred at the lowest speed of the mixer for 7 minutes and separated into 100 g samples.

Separately, a 50 wt. % solution of pMDI (polymeric methylenediphenyldiisocyanate) covalent crosslinking agent in toluene was made up. 0.4 g of this pMDI/toluene mixture, representing a pMDI/polymer weight ratio of 0.22:1 and a pMDI/glycerol ratio of about 0.66:1, was added to one of the 100 g samples with continued mixing using a Speedmixer, and then dried. A second 100 g sample serving as a control was made in exactly the same way, except that the pMDI/toluene mixture was omitted.

Both samples were exposed to humidity overnight, yielding 1% moisture uptake, after which both samples were analyzed for flowability using the flowability analytical test described in the following Example 2. It was found that the sample made with pMDI representing this invention remained free-flowing, while the control sample became a solid, rubbery cake.

This shows the effectiveness of the technology of this invention in connection with increasing the humidity resistance of our self-suspending proppants. In particular this example shows that, even though the self-suspending proppant of this invention absorbed the same amount of atmospheric moisture as the control, it still remained free flowing and did not cake or agglomerate like the control. This, in turn, shows that the effect of crosslinking in accordance with this invention is not to substantially reduce moisture absorption but rather to change the way the proppant responds to this absorbed moisture.

### Example 2

3 samples each containing 100 g of 30/50 sand were added to 3 separate FlackTek cups. Separately, a coating composition was made up containing 10 wt % glycerol and 90 wt % of a commercially-available anionic polyacrylamide invert emulsion containing approximately equal amounts of a high molecular weight hydrogel-forming anionic polyacrylamide copolymer, water and a hydrocarbon carrier liquid. The weight ratio of hydrogel forming polymer to glycerol in this coating composition was about 3:1.

3 g of this coating composition was then added to the top of each FlackTek cup, after which these containers were covered and their contents mixed at 800 rpm for 30 seconds.

A commercially-available liquid pMDI (polymeric methylenediphenyldiisocyanate) containing on the average of about 4-5 methylphenylisocyanate groups per molecule was separately added to each container in different amounts. The containers were again covered and mixed for 30 seconds at 800 rpm. The coated proppants produced thereby were then dried for 1 hour at 100° C., sieved, returned to dry their FlackTek cups, and then placed in a 90% RH, 40° C. chamber for 15 hours.

The self-suspending proppants so obtained as well as a control made in exactly the same way but without the pMDI crosslinking agent were then analyzed for moisture uptake, flowability and swelling ability. Flowability was measured using a Flodex powder flow testing apparatus available from Gardco. The Flodex equipment consists of a funnel, a cylindrical vessel with removable plates each having a different sized measuring hole, and a lever arm that covers the opening until triggered for vibration-less release of the sample.

To measure flowability, the plate with the smallest hole was fitted into the machine and the lever arm closed. The sample to be analyzed, after humidity conditioning as described above, was added to the vessel through the funnel. After 30 seconds, the lever arm was opened so that the sample could discharge through the hole of the plate. If the sample discharged evenly, it was graded as a “pass” for that hole size. If the sample did not pass through the hole when the lever arm opened, or if it formed an arch over the opening, it was graded as a “fail” for that hole size. Each test started with the plate having the smallest hole size. If the sample failed, it was tested again using the plate with next larger hole size, care being taken to make sure the sample did not dry out between tests. If the sample failed to pass through the 28 mm hole (the largest hole size in the test kit), it was regarded as not flowable. In addition, if the sample formed a solid cake before the flowability test started, it was also regarded as not flowable and not tested at all. The test results are recorded as the smallest hole size that the sample passes through, with 16 mm being the smallest hole size that was tested.

Meanwhile, the ability of these proppants to swell was tested as follows: 1 liter of water was added to each shear cell of an EC Engineering CLM4 Mixer, and the paddles of the mixer set to rotate at 275 rpm, thereby producing a shear gradient of 750 s⁻. 100 g of each proppant to be tested was then mixed for 5 minutes under these conditions, after which the mixer was stopped and the proppant allowed to settle in its shear cell. After a 10 minute settling period, the height of the settled bed of self-suspending proppant was measured.

The results of these analyses are set forth in the following Table 1:

TABLE 1
Effect of Isocyanate Amount

| Isocyanate Amount | | | Moisture | | |
|---|---|---|---|---|---|
| | Isocyanate/ | Isocyanate/ | uptake, | | Swelling ability, |
| wt. % of sand | polymer ratio | polyol ratio | wt. % sand | Flowability | mm bed height |
| 0.0 | 0 | 0 | 0.82 | Fail (solid cake) | 51.2 |
| 0.1 | 0.11:1 | 0.33:1 | 0.84 | Fail (solid cake) | 40.0 |
| 0.3 | 0.33:1 | 1:1 | 0.85 | Pass (16 mm) | 31.9 |
| 0.5 | 0.56:1 | 1.67:1 | 0.81 | Pass (16 mm) | 26.1 |

Table 1 shows that the amount of atmospheric moisture absorbed by the self-suspending proppants of this example was essentially independent of the amount of diisocyanate crosslinking agent used. In addition, this table further shows that there is a certain minimum amount of this particular covalent crosslinking agent that is necessary to produce proppants which are humidity resistant, as determined by the above flowability test. Furthermore, this table also shows that increasing amounts of covalent crosslinking agent progressively reduce the ability of these proppants to expand and hence be self-suspending. Finally, this table also shows that, while crosslinking the hydrogel polymer of our self-suspending proppants in accordance with this invention does reduce their ability to swell, still, there is region in which the degree of crosslinking is enough to make these proppants humidity-resistant when dry yet not so much to prevent these proppants from being self-suspending when wet.

Accordingly, it can be seen that, by using these results as a guide, a similar approach can be used to determine the particular amount of covalent crosslinking agent to use in additional embodiments of this invention in which other hydrogel-forming polymers, polyol coalescing agents and covalent crosslinking agents are used.

### Example 3

Another feature of our self-suspending proppants as described in our earlier applications is that their hydrogel coatings rapidly disintegrate when these proppants reach their ultimate use locations downhole. This feature is desirable, because it liberates the proppant particle substrates from which these proppants are made so that they can act like conventional proppants in terms of forming proppant packs and otherwise propping open the cracks and fissures in their geological formations. As further described in our earlier applications, this disintegration can be augmented by including in the hydrogel-forming polymer coating of these proppants, or the aqueous fracturing fluids in which these proppants are used, or both, a suitable hydrogel breaker.

To determine whether the technology of this invention would adversely affect the ability of our self-suspending proppants to break apart, the following experiment was conducted.

Additional samples of the inventive humidity and calcium ion resistant self-suspending proppants were prepared with 0.1% and 0.3% added isocyanate in the same manner as described in Example 2 above. These samples were then hydrated in generally the same manner as described above, i.e., by mixing 100 g of the sample in 1 liter at a shear gradient of 750 s⁻.

After 5 minutes, approximately 0.375-0.50 g ammonium persulfate was added and the mixture obtained subjected to gentle stirring at 100° C. for an additional 2 hours. At that time, gentle stirring was stopped and the proppants allowed to settle, after which the settled bed height of the proppants was determined.

It was found that the settled bed height of the self-suspending proppants treated in this way decreased to a level which was equal in bed height to that of plain sand. This shows that the crosslinking technology of this invention does not prevent conventional hydrogel breakers from rapidly breaking the hydrogel coatings of the inventive self-suspending proppants apart, even though these coatings have been crosslinked by an amount sufficient to make these proppants humidity-resistant when dry and calcium ion-resistant when wet.

### Example 4

This example shows the beneficial effect on calcium ion-resistance of using a cationic polyacrylamide to make the hydrogel coatings of the inventive self-suspending proppants.

A mixture containing 90% of a commercially-available cationic polyacrylamide invert emulsion containing approximately equal amounts of a high molecular weight hydrogel-forming cationic polyacrylamide copolymer, water and a hydrocarbon carrier liquid (cationic polyacrylamide emulsion polymer) and 10% glycerol was prepared by mixing the glycerol into the polymer using an overhead stirrer for 15 minutes at 800 rpm. 100 g of 20/40 sand was added to a FlackTek cup and 3 g of the polymer/glycerol mixture was added. The sand and polymer were mixed using a SpeedMixer for 30 seconds at 800 rpm. 0.2% of a commercially-available pMDI was then added and the mixture so obtained was mixed for another 30 sec at 800 rpm, after which the sample was dried for 1 hour to produce the self-suspending proppant of this example.

For the purposes of comparison, a similar the self-suspending proppant was prepared, except that its hydrogel coating was made from an anionic polyarylamide rather than the cationic polyacrylamide of this example.

The calcium ion-resistance of these self-suspending proppants was then determined using the same swellability test as described above in connection with Example 2, except that the aqueous liquid used in the test contained 2500 ppm calcium hardness. The results obtained are set forth in the following Table 2:

TABLE 2
Effect of Cationic Polyacrylamide

| | Swelling ability, |
|---|---|
| Polyacrylamide Type | mm bed height |
| Anionic (Control) | 13.9 |
| Cationic | 21.0 |

As can be seen from this table, the self-suspending proppant made with a cationic polyacrylamide in accordance with this example achieved a much greater bed height upon swelling than the control proppant made with an anionic polyacrylamide. This demonstrates the significant improvement in calcium ion resistance that can be achieved by using a cationic hydrogel-forming polymer instead of an anionic hydrogel-forming polymer.

### Example 5

To demonstrate the beneficial effect on humidity resistance that can be achieved by including a polysaccharide augmenter in the coating compositions of this invention, the following example was carried out.

A modified hydrogel polymer coating composition was made up by combining 10 wt. % glycerol with 90 wt. % of a commercially-available anionic polyacrylamide invert emulsion containing approximately equal amounts of a high molecular weight anionic polyacrylamide, water and a hydrocarbon carrier liquid. Separately, 10 parts by weight of a tertiary amine catalyst comprising (bis(3-dimethylaminopropyl)-n,n-dimethylpropanediamine) and 50 parts of a polysaccharide or oligosaccharide were added to 40 parts water to produce a series of catalyst/saccharide aqueous solutions.

A series of self-suspending proppants was made by the sequential addition to bare sand of 3 wt % of the above modified hydrogel polymer coating composition, 0.2 wt % of polymeric 4,4-methylene diphenyl diisocyanate and 0.3 wt % of one of the catalyst/saccharide aqueous solutions mentioned above. Each sample was mixed after each addition step and then dried statically in a laboratory oven for 10 min at 145° C. After drying, each sample was then exposed to a highly humid environment in the same manner as described above in connection with Example 2, i.e., by exposure to 90% RH, at 40° C. for 15 hours.

The humidity resistance of each sample was then analyzed by the same flowability test described above in connection with Example 2 in which the minimum hole size the proppants will flow through is determined. The results obtained are set forth in the following Table 3:

TABLE 3
Effect of Polysaccharide Augmenter on Flowability

| | Moisture uptake, | Flowability, Minimum |
|---|---|---|
| Polysaccharide | wt. % sand | hole size, mm |
| None | 1.00 | >28 |
| Dextrin | 1.05 | 16 |
| Maltodextrin | 1.05 | 12 |

As can be seen from this table, the presence of the polysaccharide augmenter in the hydrogel-forming polymer coatings of these self-suspending proppants had essentially no effect on moisture uptake. On the other hand, these polysaccharide augmenters had a significant beneficial effect on the flowability of these proppants in that those proppants containing these ingredients were capable of flowing through much smaller holes that the proppant made without this ingredient.

Although only a few embodiments of this invention have been described above, it should be appreciated that many modifications can be made with departing from the spirit and scope of this invention. All such modifications are intended to be included within the scope of this invention, which is to be limited only by the following claims.

1. A dry self-suspending proppant comprising a proppant particle substrate and a coating on the proppant particle substrate, wherein the coating comprises the reaction product obtained when a hydrogel-forming polymer is crosslinked by means of a covalent crosslinking agent in the presence of an organofunctional compound comprising one or more polyols, one or more polyamines or a mixture thereof, wherein the covalent crosslinking agent is also capable of reacting with the organofunctional compound.

2. The dry self-suspending proppant of claim 1, wherein the covalent crosslinking agent is selected from the group consisting of epoxides, anhydrides, aldehydes, diisocyanates, carbodiamides, divinyl compounds and diallyl compounds.

3. The dry self-suspending proppant of claim 2, wherein the covalent crosslinking agent is a diisocyanate

4. The dry self-suspending proppant of claim 3, wherein the diisocyanate is at least one of toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, a diphenylmethanediisocyanate and an isocyanate-terminated polyurethane prepolymer.

5. The dry self-suspending proppant of claim 4, wherein the diisocyanate is a mixture of diphenylmethanediisocyanates.

6. The dry self-suspending proppant of claim 1, wherein the organofunctional compound is a polyol.

7. The dry self-suspending proppant of claim 6, wherein the polyol contains 2 to 15 carbon atoms and 2 to 5 pendant hydroxyl groups.

8. The dry self-suspending proppant of claim 7, wherein the polyol contains 2 to 8 carbon atoms and 2 to 4 pendant hydroxyl groups.

9. The dry self-suspending proppant of claim 8, wherein the polyol is at least one of ethylene glycol, propylene glycol, butylene glycol, pentylene glycol, glycerol, trihydroxy butane and trihydroxy pentane.

10. The dry self-suspending proppant of claim 8, wherein the liquid polyol coalescing agent contains 3 to 8 carbon atoms and 2 to 4 pendant hydroxyl groups.

11. The dry self-suspending proppant of claim 10, wherein the liquid polyol coalescing agent is glycerol.

12. The dry self-suspending proppant of claim 11, wherein the hydrogel-forming polymer is selected from the group consisting of polyacrylamide, hydrolyzed polyacrylamide, copolymers of acrylamide with ethylenically unsaturated ionic comonomers, copolymers of acrylamide and acrylic acid salts, poly(acrylic acid) or salts thereof, carboxymethyl cellulose, hydroxyethyl cellulose, hydroxypropyl cellulose, guar gum, carboxymethyl guar, carboxymethyl hydroxypropyl guar gum, and hydrophobically associating swellable emulsion polymers.

13. The dry self-suspending proppant of claim 12, wherein the hydrogel-forming polymer is an anionic polyacrylamide.

14. The dry self-suspending proppant of claim 6, wherein the hydrogel-forming polymer is selected from the group consisting of polyacrylamide, hydrolyzed polyacrylamide, copolymers of acrylamide with ethylenically unsaturated ionic comonomers, copolymers of acrylamide and acrylic acid salts, poly(acrylic acid) or salts thereof, carboxymethyl cellulose, hydroxyethyl cellulose, hydroxypropyl cellulose, guar gum, carboxymethyl guar, carboxymethyl hydroxypropyl guar gum, and hydrophobically associating swellable emulsion polymers.

15. The dry self-suspending proppant of claim 14, wherein the hydrogel-forming polymer is an anionic polyacrylamide.

16. The dry self-suspending proppant of claim 1, wherein the organofunctional compound is a polyamine.

17. The dry self-suspending proppant of claim 16, wherein the polyamine contains 2 to 15 carbon atoms and 2 to 5 primary amine groups.

18. The dry self-suspending proppant of claim 16, wherein the hydrogel-forming polymer is selected from the group consisting of polyacrylamide, hydrolyzed polyacrylamide, copolymers of acrylamide with ethylenically unsaturated ionic comonomers, copolymers of acrylamide and acrylic acid salts, poly(acrylic acid) or salts thereof, carboxymethyl cellulose, hydroxyethyl cellulose, hydroxypropyl cellulose, guar gum, carboxymethyl guar, carboxymethyl hydroxypropyl guar gum, and hydrophobically associating swellable emulsion polymers.

19. The dry self-suspending proppant of claim 18, wherein the hydrogel-forming polymer is an anionic acrylamide polymer.

20. The dry self-suspending proppant of claim 1, wherein the amount of covalent crosslinking agent which has been used is sufficient so that the dry self-suspending proppant remains free-flowing after being subjected to a relative humidity of between about 80%-90% for one hour at 25-35° C. yet not so much as to prevent the proppant from being self-suspending when formed into an aqueous fracturing fluid.

21. The dry self-suspending proppant of claim 20, wherein the weight ratio of the amount of covalent crosslinking agent relative to the amount of hydrogel-forming polymer is 0.25:1 to 0.8:1.

22. The dry self-suspending proppant of claim 21, wherein the weight ratio of the amount of covalent crosslinking agent relative to the amount of dry self-suspending proppant is 0.7:1 to 2.5:1.

23. The dry self-suspending proppant of claim 20, wherein the weight ratio of the amount of covalent crosslinking agent relative to the amount of organofunctional compound is 0.7:1 to 2.5:1.

24. The dry self-suspending proppant of claim 1, wherein the coating comprises a hydrogel-forming polymer and an organofunctional compound which have been crosslinked together by means of a covalent crosslinking agent and a catalyst for the covalent crosslinking agent.

25. The dry self-suspending proppant of claim 24, wherein the catalyst is at least one of a sulfonic acid, an acid phosphate, a tertiary amine, lithium aluminum hydride, an organotin compound, an organozirconate and an organotitanate.

26. The dry self-suspending proppant of claim 1, wherein the coating comprises a hydrogel-forming polymer, an organofunctional compound and a polysaccharide which have been crosslinked together by means of a covalent crosslinking agent.

27. The dry self-suspending proppant of claim 26, wherein the polysaccharide is at least one of dextrin and maltodextrin.

28. The dry self-suspending proppant of claim 1, wherein the hydrogel-forming polymer is a cationic polyacrylamide.

29. An aqueous fracturing fluid comprising an aqueous carrier liquid and the self-suspending proppant of claim 1.

30. The aqueous fracturing fluid of claim 29, wherein the self-suspending proppant has swelled by an amount sufficient so that the volumetric expansion of this proppant, as measured by the Settled Bed Height Analytical Test in the specification, is ≧˜5.

31. A method of fracturing a geological formation comprising pumping into the formation the fracturing fluid of claim 29.

32. A method for making the self-suspending proppant of claim 1, comprising combining the proppant particle substrate with a coating composition comprising an aqueous emulsion of the hydrogel-forming polymer, the organofunctional compound and the covalent crosslinking agent, and thereafter causing the carrier liquid to evaporate from the coating composition.

33. The method of claim 31, wherein the covalent crosslinking agent is added to the coating composition after the proppant particle substrate, hydrogel-forming polymer and organofunctional compound are already present in the coating composition.
